(19) United States
(12) Patent Application Publication
(10) Pub. No.: US 2025/0060150 A1
(43) Pub. Date: Feb. 20, 2025

(54) METHOD FOR OPERATING A REFRIGERATION APPLIANCE

(71) Applicant: BSH Hausgeräte GmbH, München (DE)

(72) Inventors: Antje ENGSTLER, Heidenheim (DE); Tabea CHEREK, Nersingen (DE); Andras BOCSAK, München (DE); Patrick RUNDIO, Lonsee (DE); Hendrik SIEFERT, München (DE)

(21) Appl. No.: 18/802,023

(22) Filed: Aug. 13, 2024

(30) Foreign Application Priority Data
Aug. 14, 2023 (DE) 10 2023 207 789.2

(51) Int. Cl. F25D 29/00

(52) U.S. Cl. CPC F25D 29/00; F25D 2700/06

(57) ABSTRACT

A method for operating a refrigeration appliance includes determining the contents of a storage compartment of the refrigeration appliance. An operating setting is determined for the refrigeration appliance from a predetermined number of operating settings using a first trained machine learning algorithm based on the determined contents of the storage compartment. The determined operating setting is output at a user interface and/or operating the refrigeration appliance according to the determined operating setting.

### CROSS-REFERENCE TO RELATED APPLICATION

This application claims the priority, under 35 U.S.C. § 119, of German Patent Application DE 10 2023 207 789.2, filed Aug. 14, 2023; the prior application is herewith incorporated by reference in its entirety.

### FIELD AND BACKGROUND OF THE INVENTION

The present disclosure relates to a method for operating a refrigeration appliance, in particular a household refrigeration appliance such as a refrigerator, an upright or chest freezer or a fridge-freezer.

Household refrigeration appliances frequently allow chilled items with different storage condition requirements to be accommodated in different areas of a storage space. For example, household refrigeration appliances generally have a storage compartment, which is separated from the rest of the storage space. Within the storage compartment it is possible to vary at least the temperature within certain limits independently of the rest of the storage space, in order to tailor the storage conditions as effectively as possible to the contents of the refrigeration compartment. To this end the user of the refrigeration appliance is typically offered different predetermined operating settings, such as “vegetables”, “fruit”, “meat”, “fish”, “beverages” and “mixed”, defining ideal storage conditions for each type of chilled item.

In particular when chilled items with different requirements are stored together in the storage compartment, users can be unsure which operating setting to select. This generally means that the operating setting is not appropriate. On the one hand this reduces the user-friendliness of the refrigeration appliance. Also, an inappropriately selected operating setting can cause the chilled items to spoil more quickly.

Published, non-prosecuted German patent application DE 10 2021 202 247 A1, corresponding to U.S. patent publication No. 2024/0151463, discloses a method for operating a household refrigeration appliance, wherein stored items present in a refrigeration compartment of the household appliance are detected with the aid of a detection sensor. Based on the detected stored items a setpoint storage atmosphere and an acceptance storage atmosphere are determined, at which it is still and/or already acceptable to store the items. The refrigeration appliance is operated so that an actual storage atmosphere is adjusted toward the acceptance storage atmosphere.

### SUMMARY OF THE INVENTION

One of the objects of the present disclosure is to provide better solutions for the operation of a refrigeration appliance, in particular solutions which facilitate the selection of an operating setting for the refrigeration appliance and with which storage conditions can be better tailored to the contents of a storage compartment.

According to the disclosure this object is achieved by a method with the features of the independent method claim.

An inventive method for operating a refrigeration appliance includes determining the contents of a storage compartment of the refrigeration appliance, determining an operating setting for the refrigeration appliance from a predetermined number of operating settings using a first trained machine learning algorithm based on the determined contents of the storage compartment and outputting the determined operating setting at a user interface and/or operating the refrigeration appliance according to the determined operating setting. Each of the operating settings defines a temperature in the storage compartment as at least one storage parameter. Each operating setting can define additional storage parameters, such as a relative humidity in the storage compartment for example.

One idea underlying the disclosure is to select an operating setting appropriate for the respective contents of the storage compartment from a predetermined number of possible operating settings with the aid of a trained machine learning algorithm. Input for the machine learning algorithm comprises information about the contents of the storage compartment, for example in the form of a list of stored items present therein. The machine learning algorithm uses this input to determine an operating setting that represents a best common denominator in respect of storage requirements for the chilled items present in the storage compartment. The machine learning algorithm is trained in particular to take account of requirements for predetermined types or sorts of chilled items in respect of storage conditions, for example in respect of temperature and/or relative air humidity, when determining the operating setting. The determined operating setting is output at a user interface, for example as a visual or acoustic output. Alternatively or additionally, the refrigeration appliance is operated according to the determined operating setting, the temperature and, optionally, the humidity defined as storage parameters in the operating setting being set in the storage compartment.

One advantage of the disclosure is that the machine learning algorithm is only selected from a predetermined number of possible operating settings. This advantageously reduces the computation resources required and shortens response times. It also prevents the user being overloaded with unnecessary information as one of the known settings is constantly output. This enhances user-friendliness.

A further advantage of the disclosure is that an appropriate operating setting is reliably determined using the machine learning algorithm even when there is a mix of stored items with different requirements for storage conditions. This optimizes shelf life in particular in the case of food.

Advantageous embodiments and developments will emerge from the subclaims relating to the independent claims in conjunction with the description.

According to some embodiments provision can be made for the determination of the contents of the storage compartment to comprise a determination of the type and number of objects present in the storage compartment. Determination of the type or nature of an object can mean for example that the objects are identified as belonging to different categories or groups. Categories can include for example: vegetables, fruit, meat, fish, delicatessen, cheese, beverages, other or unknown. As already outlined briefly above, the input for the first machine learning algorithm can be a list setting out the number and type of the objects present in the storage compartment.

According to some embodiments provision can be made for the first machine learning algorithm to be trained to determine the operating setting based on the type and number of objects determined as being present in the storage compartment. In other words the machine learning algorithm can be trained to take account not only of the type of the objects and therefore their storage requirements but also their number. For example if a large proportion of the contents corresponds to objects of a first type, for example beverages, and only a small number are of a second type, for example vegetables, the machine learning algorithm can determine an operating setting appropriate for the majority first type present. Depending on the types of objects present in combination, the machine learning algorithm can however also determine an operating setting more appropriate for the minority type present, for example if these are more sensitive. For example if meat, which is best stored at a temperature of around −1° C., is predominantly present and only one lettuce or other vegetables, which keep longest at temperatures a little above 0° C., are present in the storage compartment, an operating setting can be selected, which defines a temperature above 0° C., to prevent the lettuce being damaged very quickly at a temperature below 0° C. This means that the requirements of all the objects present in the storage compartment are taken adequately into account and shelf life overall can be extended.

According to some embodiments provision can be made for the first machine learning algorithm to be trained to identify the most sensitive type of objects in the determined contents in respect of storage parameter requirements and to determine the operating setting from the predetermined number of operating settings that defines storage parameters that are compatible with the requirements of the identified most sensitive type. For example some types of objects, for example lettuce or liquids, are particularly sensitive in respect of a very low temperature and air humidity, while other types of objects, for example fish, are particularly sensitive in respect of a high air humidity. Unless there are essentially contradictory requirements, the machine learning algorithm can select an operating setting that extends the shelf life of the most sensitive type. Even if this shortens the shelf life of other types, the shelf life of the contents overall can be extended.

According to some embodiments provision can be made for the first machine learning algorithm to be trained to identify combinations of contents that are incompatible in respect of operating setting requirements and, if an incompatible combination is identified, to generate a recommendation that is output at the user interface and/or to determine a mixed contents operating setting from the predetermined number of operating settings. The recommendation can be output for example at the user interface as a visual or acoustic output. The content of the recommendation can include for example information about a probable maximum shelf life of the incompatible objects at the mixed contents operating setting, such as “shelf life of lettuce probably less than 2 days”. Alternatively or additionally the content of the recommendation can include suggestions that the user change the combination of contents, for example by taking out one of the incompatible types, for example “store fish elsewhere”. It is also conceivable for the recommendation to suggest that individual objects should be packaged in a specific manner. The mixed contents operating setting can be for example a standard operating setting, for example a temperature between 1° C. and 4° C. and, optionally, a low relative air humidity, for example between 40% and 70%.

According to some embodiments provision can be made for determination of the contents of the storage compartment to comprise an acquisition of image data with the aid of an imaging sensor and determination of objects present in the storage compartment from the image data with the aid of a second trained machine learning algorithm. For example an imaging sensor, for example a CMOS sensor, IR sensor or the like, can be arranged in the storage compartment, to acquire a digital image of the contents of the storage compartment. The second machine learning algorithm receives the image data as input and outputs data, in which the objects present in the storage compartment are identified at least by type and optionally also by their respective number. The second trained machine learning algorithm can thus be trained to identify specific types and number of objects from the image data. An output of the second machine learning algorithm could be for example a list, which indicates the type of identified objects and their respective number. The identified objects could already be combined by category in the process.

According to some embodiments provision can be made for determination of the contents of the storage compartment to comprise receipt of an input at an input interface. The input interface can be for example a user interface of the appliance, for example a touch display or the like. Alternatively the input interface can also be formed by a mobile terminal, for example a smartphone or the like, on which a software application is run to receive a corresponding input. It is also conceivable for the input interface to be formed by an optical sensor, which can be provided either on the refrigeration appliance itself or on a mobile terminal, the sensor acquiring a coding system representing the contents of the storage compartment and the contents of the storage compartment being determined on that basis. The coding system can be for example a sales receipt, on which the objects forming the contents of the storage compartment are listed. The coding system can also be formed by barcodes, QR codes or the like, which are shown for example on the respective packaging of the object to be accommodated in the storage compartment. The optical sensor can then be used to scan the code to generate an input defining the contents.

According to some embodiments provision can be made for the operating settings each also to define a moisture content, for example in the form of a relative air humidity, in the storage compartment.

According to some embodiments provision can be made for the storage compartment to be defined by a sub-region of a refrigeration space of the refrigeration appliance, it being possible for an exchange of air between the storage compartment and the rest of the refrigeration space to be varied with the aid of a movable separating structure and the position of the separating structure being varied to adjust the moisture content during operation of the refrigeration appliance according to the determined operating setting. The storage compartment can be formed by a drawer for example, the interior of which is separated from the rest of the storage space by an intermediate floor when moved inward. This allows a storage atmosphere to be set in the storage compartment that is different from the rest of the storage space, in particular in respect of temperature and humidity. The separating structure can be formed for example by a flap or slider at the end of the intermediate floor, by way of which a connection can be established for conducting fluid between the storage compartment and the rest of the storage space and a flow cross section can be varied by the separating structure. This allows an exchange of air between the storage compartment and the rest of the storage space and therefore the moisture content in the storage compartment to be varied. When the separating structure is open or the flow cross section is large, the moisture content in the storage space is reduced.

According to some embodiments provision can be made for the method also to comprise the generation of a set of rules, which defines non-permissible storage parameters in operating settings for the determined contents, based on the determined contents and rules, in which limit values are set for the storage parameters for a predetermined number of categories, to which the determined contents of the storage compartment can be assigned, a comparison of the determined operating setting with the set of rules and determination of a new operating setting, if the determined operating setting infringes the set of rules. The rules can be available for example in the form of a look-up table, showing minimum and maximum storage temperatures and, optionally, a minimum and maximum air humidity for storage for a plurality of types of objects or chilled items. To generate the set of rules the respective entries can be downloaded from the look-up table for each object in the contents of the storage compartment and compared with the storage parameters of the determined operating setting. If the operating setting includes a storage parameter which is greater than or smaller than the limit values specified in the set of rules, a new and different operating setting is determined. This provides an additional safety check, to verify the result output by the first machine learning algorithm, thereby further reducing the possibility of an incorrect setting.

According to some embodiments provision can be made for the first machine learning algorithm to output multiple potential operating settings in a sequence, the potential operating settings being compared with the set of rules in the output sequence and, if the respective operating setting infringes the set of rules, the next operating setting in the sequence being determined as the new operating setting.

According to some embodiments provision can be made for the outputting of the determined operating setting at the user interface to comprise an input request to select the determined operating setting, the refrigeration appliance then only being operated according to the determined operating setting when an input is made at the user interface in response to the input request. For example, information about the determined operating setting can be output at the user interface, in other words for example at a display unit of the refrigeration appliance or on a mobile terminal. A request can also be output at the user interface to confirm or reject the determined operating setting, for example in a dialog field. The refrigeration appliance is only operated according to the determined operating setting when an input is received at the interface confirming the operating setting.

According to some embodiments provision can be made for the outputting of the determined operating setting at the user interface also to comprise an outputting of further operating settings and the outputting of an input request to select the determined operating setting or one of the further operating settings, the refrigeration appliance being operated according to the selected operating setting in response to receipt of an input at the user interface selecting one of the output operating settings. Further operating settings, which can be activated by a corresponding input, can then be proposed to the user in addition to the operating setting determined using the first machine learning algorithm.

According to some embodiments provision can be made for a refrigerant circuit of the refrigeration appliance to be operated during operation of the refrigeration appliance according to the determined operating setting, to vary the temperature in the storage compartment according to the determined operating setting.

According to some embodiments provision can be made for the first machine learning algorithm to be stored in a storage medium of the refrigeration appliance and to be run by a processor of the refrigeration appliance. For example, the refrigeration appliance can have a control device, which has a processor, for example in the form of a CPU, ASIC, FPGA or the like, and a non-volatile storage medium, for example an SD storage device, EEPROM storage device or flash storage device or the like. The control device can also have a communication interface, which is or can be connected to the user interface to exchange data wirelessly or by cable. In some instances the second machine learning algorithm can also be stored in the same or a different storage medium of the refrigeration appliance and run by a processor of the refrigeration appliance. The control device receives the input the first and in some instances the second machine learning algorithm requires, in other words for example the image data acquired by means of the sensor or the input representing the contents of the storage compartment, by way of the communication interface. After running the respective algorithm a control signal can be output at the communication interface to operate the refrigeration appliance according to the determined operating setting, and/or an information signal can be output to output the determined operating setting at the user interface.

According to some embodiments provision can be made for the data specifying the contents to be transferred, for example with the aid of a communication interface of the refrigeration appliance, to a web-based virtual machine, which runs the first machine learning algorithm stored in a cloud storage medium. In other words the image data or data input at the user interface of the refrigeration appliance or a mobile terminal and specifying the contents of the storage compartment is not processed locally at the refrigeration appliance but instead sent to a cloud-based back end, where the first and optionally also the second machine learning algorithm is/are run. The virtual machine sends the determined operating setting to the user interface and/or to a communication interface of the refrigeration appliance.

According to some embodiments provision can be made for the outputting of the determined operating setting at the user interface to comprise the generation of an output at an interface of the refrigeration appliance. As mentioned above, this can comprise for example the generation of a visual output on a display unit of the refrigeration appliance. Alternatively or additionally, the outputting of the determined operating setting at the user interface can comprise the transfer of a communication signal to a mobile terminal, for example with the aid of a communication interface of the refrigeration appliance, and the generation of an output by the mobile terminal to output the determined operating setting in response to receipt of the communication signal.

According to some embodiments provision can be made for the first machine learning algorithm to be based on an artificial neural network or an XGBoost algorithm. This also applies for any second machine learning algorithm deployed.

According to some embodiments provision can be made for the refrigeration appliance to be a refrigerator, an upright or chest freezer or a fridge-freezer.

According to some embodiments the predetermined number of operating settings can comprise one or more of the following operating settings:
“meat”, the storage parameter being defined as a temperature between −2° C. and −1° C. and, optionally, low air humidity,
“fish”, the storage parameter being defined as a temperature between-2° C. and −1° C. and, optionally, low air humidity,
“vegetables”, the storage parameter being defined as a temperature between 0° C. and 4° C. and, optionally, high air humidity,
“fruit”, the storage parameter being defined as a temperature between 0° C. and 4° C. and, optionally, lower air humidity,
“fruit and vegetables”, the storage parameter being defined as a temperature between 0° C. and 4° C. and, optionally, low air humidity,
“beverages”, the storage parameter being defined as a temperature between 1° C. and 14° C. and, optionally, low air humidity, and
“mixed contents”, the storage parameter being defined as a temperature between 0° C. and 4° C. and, optionally, low air humidity.

Low air humidity can be for example a relative air humidity between 40% and 85%. High air humidity can be for example a relative air humidity greater than 85%.

Machine learning algorithms may be computational models or methods that enable machines to learn and make predictions or decisions without being explicitly programmed. These algorithms use statistical techniques to analyze large amounts of data, identify patterns, and make predictions or decisions based on the patterns observed. The goal of machine learning algorithms is to automatically learn from data and improve their performance over time. There are various types of machine learning algorithms, including supervised learning algorithms, unsupervised learning algorithms, and reinforcement learning algorithms, each designed to address different learning tasks and scenarios.

Training data for the machine learning algorithm may be labeled or annotated data that is used to train the algorithm. This data consists of input examples or instances, along with their corresponding correct outputs or labels. The training data is crucial for the machine learning algorithm to learn patterns and relationships between the input data and the desired outputs. By exposing the algorithm to a diverse and representative set of training data, it can learn to make accurate predictions or decisions on new, unseen data. The specific type and format of the training data depend on the type of machine learning algorithm and the task at hand. For supervised learning algorithms, the training data includes both input features and the corresponding correct labels. In contrast, unsupervised learning algorithms do not require labeled training data. Instead, they learn patterns and structures directly from the input data. Examples of unsupervised learning tasks include clustering, dimensionality reduction, and anomaly detection. It is important to ensure that the training data is representative of the real-world scenarios the algorithm will encounter. It should cover a wide range of possible inputs and include both positive and negative examples to avoid bias and overfitting. Additionally, the training data should be properly preprocessed and cleaned to remove any noise or irrelevant information that may hinder the learning process.

Object recognition by machine learning algorithms may involve training a model to identify and classify objects within images or videos. A general overview of the training method may be initially based on gathering of a large dataset of images or videos that contain the objects you want to recognize. The dataset should include a diverse range of object instances and variations in lighting, background, and orientation. Then preprocessing of the data to ensure consistency and improve the learning process. This may involve resizing images, normalizing pixel values, and augmenting the dataset with transformations like rotation, scaling, or flipping. Then extracting relevant features from the images or videos to represent the objects. Traditional methods include handcrafted features like Histogram of Oriented Gradients (HOG) or Scale-Invariant Feature Transform (SIFT). However, deep learning models, such as Convolutional Neural Networks (CNNs), have shown superior performance by automatically learning discriminative features. Then training the machine learning algorithm using the preprocessed data and the extracted features. For deep learning models like CNNs, this involves feeding the images or video frames through the network, adjusting the model's weights through backpropagation, and optimizing a loss function. Then assessing the trained model's performance using a separate validation dataset. This helps to measure accuracy, precision, recall, and other evaluation metrics. Adjustments can be made to the model architecture or training process to improve performance. Finally, deploying to recognize objects in new, unseen images or videos. The model takes the input, processes it, and produces predictions or labels for the objects present. It is important to note that the specific details and techniques used for object recognition can vary depending on the algorithm and the specific requirements of the task. Experimentation and fine-tuning may be necessary to achieve optimal results.

The machine learning algorithm may be based for example on an artificial neural network. A neural network is a computational model inspired by the structure and functioning of the human brain. It is a network of interconnected nodes, called artificial neurons or “nodes,” that work together to process and transmit information. In a neural network, information flows through the network in the form of numerical inputs, which are passed through the nodes. Each node applies a mathematical operation to the inputs it receives and produces an output. These outputs are then passed to other nodes in the network, forming a complex network of interconnected nodes. Neural networks are typically organized into layers, including an input layer, one or more hidden layers, and an output layer. The input layer receives the initial input data, while the hidden layers perform computations and extract features from the data. The output layer produces the final output or prediction based on the computations performed by the hidden layers. Neural networks may be trained using a process called “backpropagation,” where the network adjusts its internal parameters, known as weights and biases, to minimize the difference between its predicted outputs and the desired outputs. This training process allows neural networks to learn and generalize from the data, making them capable of tasks such as pattern recognition, classification, regression, and other complex decision-making tasks. For example, a Convolutional Neural Networks (CNN) may be used for image recognition tasks, including food recognition. They are designed to automatically learn and extract relevant features from images. CNNs consist of multiple layers, including convolutional layers for feature extraction, pooling layers for downsampling, and fully connected layers for classification. CNNs have achieved high accuracy in food recognition tasks due to their ability to capture spatial relationships in images. For a further example, a Support Vector Machines (SVM) is a supervised learning algorithm that may be used for food recognition. SVMs find an optimal hyperplane that separates different food categories in a high-dimensional feature space. SVMs are effective in handling high-dimensional data and can handle both linear and non-linear classification tasks. For a further example, a Random Forests is an ensemble learning algorithm that combines multiple decision trees to make predictions. It may be used for food recognition by training decision trees on various features extracted from food images. Random Forests are known for their ability to handle high-dimensional data, handle missing values, and avoid overfitting. Apart from CNNs, other deep learning models such as Recurrent Neural Networks (RNNs) and Long Short-Term Memory (LSTM) networks may also be used for food recognition tasks. These models are particularly useful when dealing with sequential data, such as recipe ingredients or food descriptions. The choice of algorithm depends on factors such as the size and quality of the dataset, computational resources, and the specific requirements of the food recognition task. It is recommended to experiment with different algorithms and architectures to find the one that best suits your needs.

Other features which are considered as characteristic for the invention are set forth in the appended claims.

Although the invention is illustrated and described herein as embodied in a method for operating a refrigeration appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a refrigeration appliance;

FIG. 2 is a schematic sectional diagram of the refrigeration appliance;

FIG. 3 is a schematic diagram illustrating an exchange of data between the refrigeration appliance, a mobile terminal and a cloud system;

FIG. 4 is a flow diagram of the sequence of a method for operating the refrigeration appliance according to an exemplary embodiment of the disclosure;

FIG. 5 is a block diagram of a second machine learning algorithm deployed in a method for operating a refrigeration appliance according to an exemplary embodiment of the disclosure;

FIG. 6 is a block diagram of a first machine learning algorithm deployed in a method for operating a refrigeration appliance according to an exemplary embodiment of the disclosure; and

FIG. 7 is a schematic diagram of a decision tree, according to which the first machine learning algorithm can be trained.

In the figures identical components or those of identical function are designated by the same reference characters, unless otherwise stated.

### DETAILED DESCRIPTION OF THE INVENTION

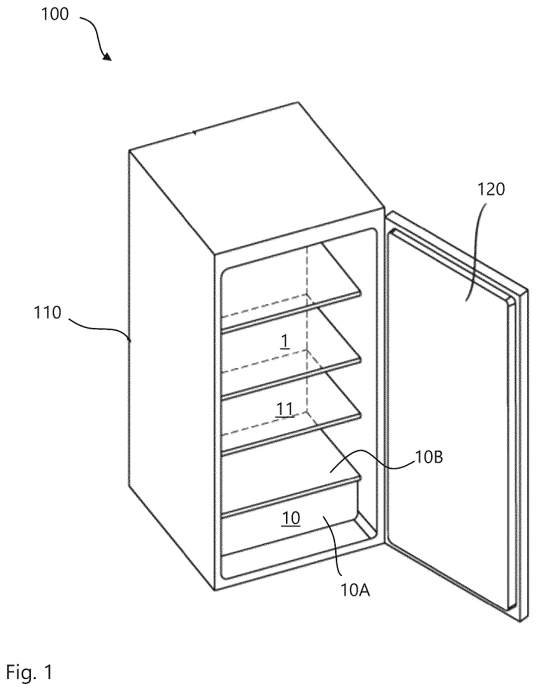

Referring now to the figures of the drawings in detail and first, particularly to FIG. 1 thereof, there is shown by way of example a refrigeration appliance 100 in the form of a refrigerator. As shown schematically in FIG. 1, the refrigeration appliance 100 has a body 110, which defines a storage space 1 for holding chilled items, for example food, beverages, medication or the like. The refrigeration appliance 100 can also have doors 120 supported on the body 110 to close off the storage space 1. As shown schematically in FIG. 1, the storage space 1 can be divided into a first storage compartment 10 and a second storage compartment 11. In the example in FIG. 1 the first storage compartment 10 is delimited by a pull-out drawer 10A and separated from the second storage compartment 11 by an intermediate floor 10B. However, the invention is not restricted to this. The first storage compartment 10 can also be located for example behind the drawer or be delimited in some other manner. Generally the first storage compartment 10 forms a sub-space, which is or can be separated physically from the rest of the storage space 1 and optionally is or can be connected for conducting fluid to the rest of the storage space 1.

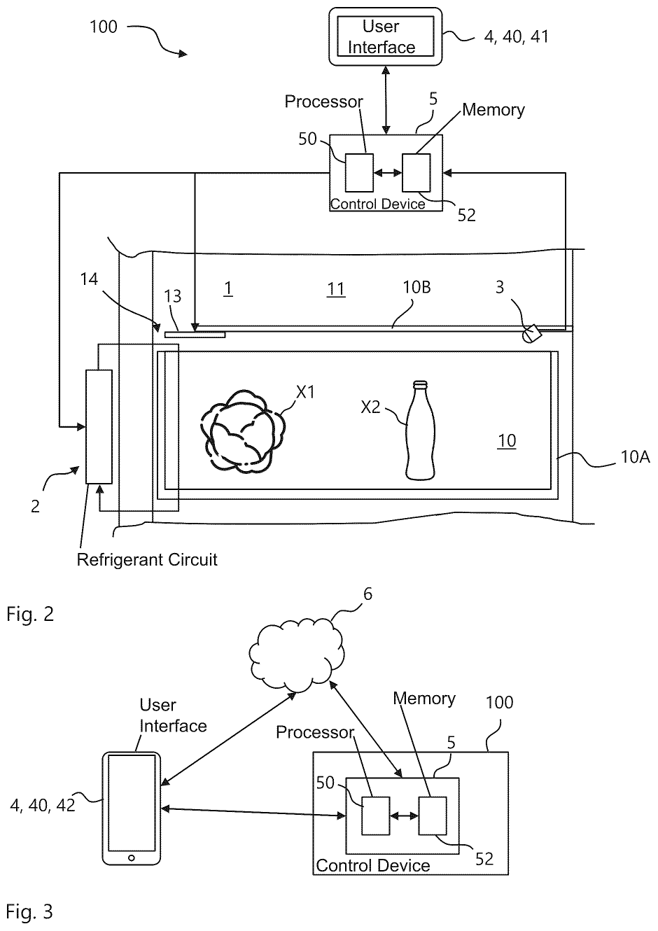

FIG. 2 is a purely schematic partially sectional view of the refrigeration appliance 100 in the region of the first storage compartment 10. As shown schematically in FIG. 2, the refrigeration appliance 100 also has a refrigerant circuit 2, which is configured to draw heat from the storage space 1 as refrigerant evaporates and to output the heat to the environment as the refrigerant condenses. The refrigerant circuit 2 is shown purely symbolically in FIG. 2 and its structure is known in principle. For example the refrigerant circuit 2 can have an evaporator (not shown) coupled thermally to the storage space 1, a compressor (not shown) to compress the gaseous refrigerant coming from the evaporator, a condenser (not shown) to condense the compressed refrigerant and a throttling device (not shown) to expand the refrigerant. In particular the refrigerant circuit 2 can be configured to set different temperatures in the first and second storage compartments 10, 11. To this end air can be circulated for example in a targeted manner between an evaporator chamber (not shown), in which the evaporator of the refrigerant circuit 2 is arranged, and the storage compartments 10, 11.

As also shown schematically in FIG. 2, the refrigeration appliance 100 can have a movable separating structure 13, for example in the form of a slider. The separating structure 13 can be moved for example within a gap 14 connecting the first and second storage compartments 10, 11, to vary the width of the gap 14. For example the separating structure 13 can be moved between a closing position, in which it completely closes or covers the gap 14, and an opening position, in which it at least partially exposes the gap 14. The movement of the separating structure 13 can be brought about for example by way of a servomotor (not shown). By changing the width of the gap 14 it is possible to vary the exchange of air between the first and second storage compartments 10, 11, thereby influencing the air humidity in the first storage compartment 10.

The refrigeration appliance 100 can also optionally contain an imaging sensor 3, for example in the form of a CMOS sensor, IR sensor or the like. As shown schematically in FIG. 2, the imaging sensor 3 can be directed for example toward the first storage compartment 10, to acquire image data from the interior of the first storage compartment 10. As shown schematically in FIG. 2, different objects X1, X2 can be stored as chilled items or contents in the first storage compartment 10. Image data of the contents of the first storage compartment 10 can be acquired using the sensor 3.

As also shown schematically in FIG. 2, the refrigeration appliance 100 can have a user interface 41, for example in the form of a display unit, in particular a touch display. The user interface 41 can be configured in particular to generate visual and/or acoustic output. The user interface 41 can optionally also be configured to receive input, for example by way of the touch display.

As also shown in FIG. 2, the refrigeration appliance 100 can have a control device 5. The control device 5 can have a processor 50 and a data storage medium 52. The processor 50 is a computation unit, which is configured to generate electrical output signals based on electrical input signals. The processor 50 can be for example a CPU, ASIC, FPGA or the like. In particular the processor 50 can be configured to run software, which is stored in the data storage medium 52. The data storage medium 52 can in particular be a non-volatile data storage medium, for example an SD storage device, EEPROM storage device, flash storage device or the like. The control device 5 can also have one or more communication interfaces, by way of which the control device 5 is connected to the refrigerant circuit 2 and optionally the sensor 3 and/or user interface 41. The control device 5 can also optionally be connected by way of the communication interface to a humidity sensor (not shown) arranged in the first storage compartment 10. The communication interface can be formed by just one or multiple physical interfaces and can be configured to communicate by cable, for example by way of a bus system, and/or wirelessly, for example by way of WiFi, Bluetooth, LTE or the like.

As shown simply by way of example and purely schematically in FIG. 3, the refrigeration appliance 100 can be configured to communicate with a web-based cloud system 6 and/or mobile terminals, such as smartphones, tablet PCs or the like. For example the communication interface of the control device 5 can be configured to send data wirelessly to a mobile terminal and/or receive data wirelessly therefrom, for example by way of a Bluetooth connection or WiFi. Alternatively or additionally the communication interface of the control device 5 can be configured to send data to the cloud system 6 and/or receive data therefrom.

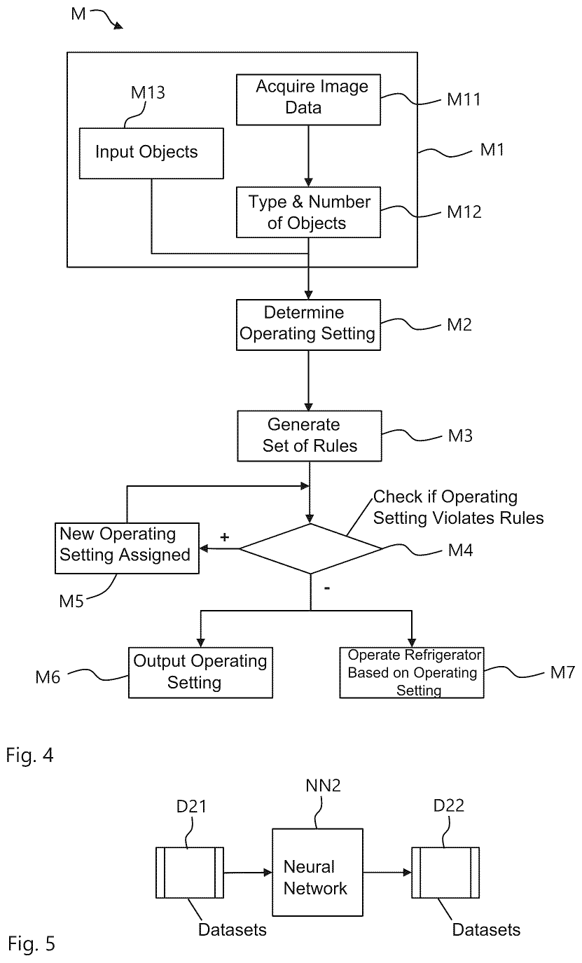

FIG. 4 shows a schematic diagram of the sequence of a method M for operating a refrigeration appliance 100, described in the following with reference to the refrigeration appliance 100 explained with reference to FIGS. 1 to 3. The invention is however not restricted hereto. In particular the refrigeration appliance 100 can generally be a household refrigeration appliance, for example a refrigerator, an upright or chest freezer or a fridge-freezer. Reference is made by way of example in the following to a method which is only applied to the first storage compartment 10. However the invention is not restricted hereto and the method M can be used for all storage compartments of a refrigeration appliance 100.

In step M1 the contents of a storage compartment 10, 11 of the refrigeration appliance 100 are determined. In step M1 the number and type of the objects X1, X2 present in the first storage compartment 10 can generally be determined. For example in a first sub-step M11 image data can be acquired M11 with the aid of the imaging sensor 3. In a further sub-step M12 the type and number of the objects X1, X2 present in the first storage compartment 10 can be determined from the image data. This can be done for example with the aid of a trained machine learning algorithm. This is shown schematically in FIG. 5. The machine learning algorithm can be based for example on an artificial neural network NN2, which receives the image data D21 as input and outputs a dataset D22 representing the number and type of the objects X1, X2 as output. FIG. 2 shows for example that a first object X1 is a lettuce and a second object is a bottle X2. The machine learning algorithm here can output for example a dataset containing the following details: type/number: vegetables/1, beverages/1. Determination of the type or nature of the objects X1, X2 can generally comprise for example identifying them as belonging to different categories or groups. Categories can include for example: vegetables, fruit, meat, fish, delicatessen, cheese, beverages, other, unknown. It is however also possible to determine the type individually, for example rather than “vegetables”, additionally specifying “tomato”, “lettuce”, broccoli”, etc.

The machine learning algorithm NN2 can be stored for example in the data storage medium 52 of the control device 5 and be run by the processor 50. Alternatively, the machine learning algorithm NN2 can be stored in a storage device of the cloud system 6 and be run by a virtual machine of the cloud system 6. The image data acquired by the sensor 3 can then be sent to the cloud system 6 by way of the communication interface of the control device 5.

Alternatively or additionally, to determine the contents with the aid of the imaging sensor 3 and deployment of the machine learning algorithm NN2 (also referred to as the second machine learning algorithm in the following), in sub-step M13 an input can also be received at an input interface 40. The input interface 40 can be formed for example by the user interface 41 of the refrigeration appliance 100 or by the mobile terminal 42. In both instances the user can input the objects X1, X2 present in the storage compartment 10 manually, for example by way of an input mask or scan them with the aid of a further sensor (not shown), for example from a shopping list, sales receipt or by way of codes on the respective object X1, X2. The input contents of the storage compartment 10 can be sent from the mobile terminal 42 for example to the cloud system 6 and/or to the control device 5 of the refrigeration appliance 100. In the same way the control device 5 can receive the input from the user interface 41 and optionally send it to the cloud system 6.

In step M2 of the method M an operating setting of the refrigeration appliance 100 is determined from a predetermined number of operating settings by a further trained machine learning algorithm (in the following also first machine learning algorithm) based on the contents of the storage compartment 10, 11 determined in step M1. The operating setting of the refrigeration appliance 100 can define different storage parameters but as a minimum the temperature in the first storage compartment 10 and optionally also a humidity, for example a relative air humidity, in the first storage compartment 10.

The predetermined number of operating settings, from which the first machine learning algorithm determines an operating setting, can comprise for example one or more of the following operating settings:
“meat”, the storage parameter being defined as a temperature between −2° C. and −1° C. and, optionally, low air humidity,
“fish”, the storage parameter being defined as a temperature between-2° C. and −1° C. and, optionally, low air humidity,
“vegetables”, the storage parameter being defined as a temperature between 0° C. and 4° C. and, optionally, high air humidity,
“fruit”, the storage parameter being defined as a temperature between 0° C. and 4° C. and, optionally, low air humidity,
“fruit and vegetables”, the storage parameter being defined as a temperature between 0° C. and 4° C. and, optionally, low air humidity,
“beverages”, the storage parameter being defined as a temperature between 1° C. and 14° C. and, optionally, low air humidity, and
“mixed contents”, the storage parameter being defined as a temperature between 0° C. and 4° C. and, optionally, low air humidity.

Low air humidity can be for example a relative air humidity between 40% and 85%. High air humidity can be for example a relative air humidity greater than 85%.

The first machine learning algorithm can be stored for example in the storage medium 52 of the control device 5 and run by the processor 50. Alternatively the first machine learning algorithm can be stored in the cloud system 6 and run by a virtual machine of the cloud system 6. The data specifying the contents of the first storage compartment 10 must then be sent to the cloud system 6, for example with the aid of a communication interface of the control device 5 or directly from the mobile terminal 41, or the cloud system 6 must receive the image data and perform the sub-steps M11 and M12, as described above.

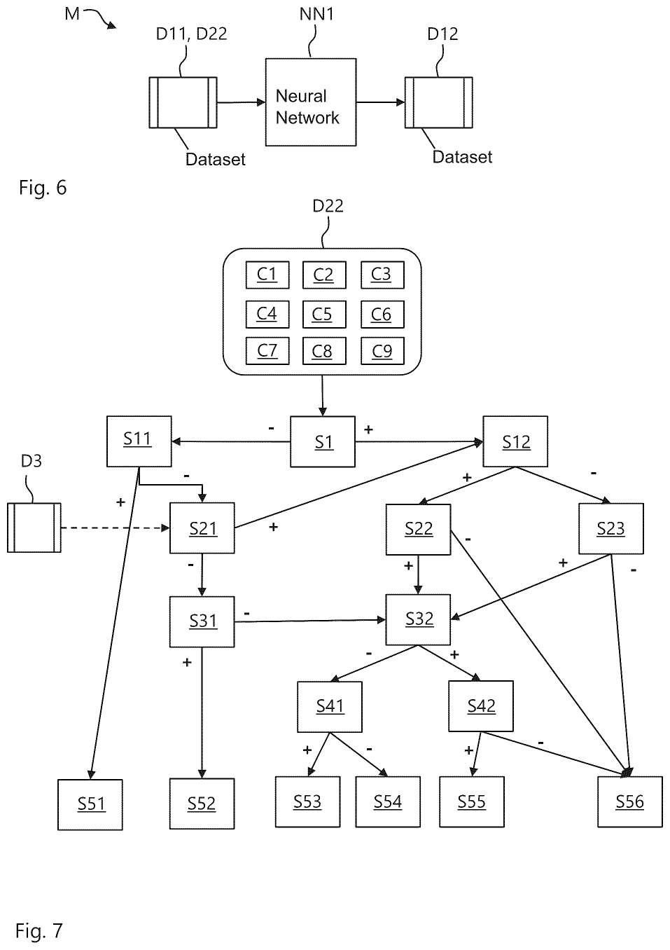

As shown schematically in FIG. 6, the first machine learning algorithm can be based for example on an artificial neural network NN1, which receives input in the form of a dataset D11, which specifies the contents of the first storage compartment 10, for example by the type and number of the objects X1, X2 present therein. For example the first machine learning algorithm can receive the dataset D22 output by the second machine learning algorithm. The output of the first machine learning algorithm is a dataset D12, which indicates the operating setting of the refrigeration appliance 100, in other words for example “vegetables”, and specifies for example a setpoint temperature and optionally a setpoint humidity in the first storage compartment 10.

The first machine learning algorithm can generally be trained, for different combinations of objects X1, X2 present in the storage compartment 10 in each instance, to select an operating setting from the predetermined number of operating settings, which takes the best possible account of the requirements of the objects X1, X2 in respect of storage parameters.

FIG. 7 shows a schematic and purely exemplary diagram of different rules, according to which the first machine learning algorithm can be trained.

As shown schematically in FIG. 7, the first machine learning algorithm can receive the dataset D22 output by the second machine learning algorithm as input. As shown schematically in FIG. 7, the dataset D22 can contain information about the type and number of objects determined as the contents of the storage compartment 10. The dataset D22 shown by way of example in FIG. 7 can have fields for example for the following types: vegetables C1, fruit C2, meat C3, fish C4, delicatessen C5, cheese C6, beverages C7, unknown C8 and fruit and vegetables C9.

In a first check step S1 it can be asked for example whether objects X1, X2 have been identified as “unknown C8”. If not, as shown in FIG. 7 by the symbol “−”, the method moves to check step S11, otherwise to check step S12, as shown by the symbol “+”.

In check step S11 it can be checked whether all the objects X1, X2 are of the same type, in other words for example fish C4. If so, as shown in FIG. 7 by the symbol “+”, the method moves directly to block S51 and the operating setting for the respective type is output.

If it is determined in check step S11 that not all the objects X1, X2 are of the same type, as shown in FIG. 7 by the symbol “−”, the method moves to step S21, in which it is checked whether there are types in the storage compartment 10 that are incompatible in respect of their storage condition requirements. As shown purely symbolically in FIG. 7, a dataset D3 for example, which defines possible incompatibilities, for example fish C4 is incompatible with all other types except meat C3, meat C3 is incompatible with vegetables C1, fruit C2 and cheese C6, and cheese C6 is incompatible with fruit C2, vegetables C1, fish C4 and meat C3, can be used for this purpose. When one of these combinations is identified in block S21, as shown in FIG. 7 by the symbol “+”, the check system moves to step S12; otherwise, if no incompatibility has been identified, as shown by the symbol “−”, the check system moves to check step S31.

In check step S31 it is determined whether the different types are present in roughly the same number in the storage compartment 10. For example numerical deviations, or those based on a mass of the respective types calculated approximately from the number, of up to 10% can be considered to be the same number. If the different types are present in roughly the same number in the storage compartment 10, as shown in FIG. 7 by the symbol “+”, the check system moves to block S52. In block S52 the operating setting stored for the respective combination can be selected from a table (not shown), in which an operating setting is assigned to each combination of compatible types. In blocks S51, S52 therefore ideal operating settings can be determined for the determined contents. If in step S31 it is determined that the different types are not present in roughly the same number in the storage compartment 10, as shown in FIG. 7 by the symbol “−”, the check system moves to step S32.

In check step S12 it is checked whether one of the types makes up the majority of the contents of the storage compartment 10, in other words is present in a simple majority numerically or in respect of estimated mass, or optionally makes up more than 50% of the contents. If not, as shown in FIG. 7 by the symbol “−”, the check system moves to step S23. If it is determined in step S12 that one of the types makes up the majority of the contents of the storage compartment 10, as shown in FIG. 7 by the symbol “+”, the system moves to block S22.

In block S23 it can be checked whether the combination fruit and vegetables C9 makes up a majority of the contents of the storage compartment 10. Fruit and vegetables are relatively sensitive in respect of storage parameters. For example they generally spoil very quickly when the temperature is too low. If it is determined in block S23 that the combination fruit and vegetables C9 makes up a majority of the contents of the storage compartment 10, as shown by the symbol “+”, the check system moves to block S32. Otherwise, as shown in FIG. 7 by the symbol “−”, the system moves to block S56. The operating setting “mixed contents” is selected in block S56.

In block S22 it is checked whether the majority of the contents of the storage compartment 10 has not been identified as “unknown C8”, for example a simple majority or more than 50% of the objects has not been classified as “unknown”. If not, as shown in FIG. 7 by the symbol “−”, the system moves to block S56, in which the operating setting “mixed contents” is selected. If the majority of the contents of the first storage compartment 10 is unknown, the operating setting “mixed contents” can thus be selected. If it is determined in block S22 that the majority of the contents of the storage compartment 10 has not been identified as “unknown C8”, as shown by the symbol “+”, the check system moves to block S32.

In check step S32 it can be checked whether fish C4 or meat C3 have been identified as types. If fish C4 or meat C3 is identified as a type, as shown in FIG. 7 by the symbol “+”, the check system moves to block S42, in which it is checked whether the identified contents consist solely of fish and/or meat. If not, as shown in FIG. 7 by the symbol “−”, the system moves to block S56 and the operating setting “mixed contents” is selected. Otherwise, as shown in FIG. 7 by the symbol “+”, the system moves to block S55, in which the operating setting “fish” is selected if fish C4 is the majority type present and the operating setting “meat” is selected if meat C3 is the majority type present.

If it is determined in check step S32 that there is no fish C4 and no meat C3 in the identified types, as shown by the symbol “−”, the system moves to block S41. In block S41, as in step S23, it can be checked whether the combination fruit and vegetables C9 makes up the majority of the contents of the storage compartment 10. If so, as shown in FIG. 7 by the symbol “+”, the system moves to block S53, in which “fruit and vegetables” is selected as the operating setting. Otherwise, as shown in FIG. 7 by the symbol “−”, the system moves to block S54, in which the operating setting for the majority type present is selected.

Generally therefore the first machine learning algorithm can be trained to determine the operating setting based on the type and number of the objects X1, X2 determined as being present in the storage compartment 10, 11.

The first machine learning algorithm can optionally also be trained to identify the most sensitive type of objects in the determined contents in respect of storage parameter requirements and to determine the operating setting from the predetermined number of operating settings, which defines storage parameters that are compatible with the requirements of the identified most sensitive type.

As set out above, the machine learning algorithm can be trained for example to identify incompatibilities among the types and take these into account when selecting the operating setting, for example by selecting the operating setting “mixed contents”, in particular when a type that is incompatible with the other types is not present as a majority.

Again with reference to FIG. 4, in step M2 the first machine learning algorithm again outputs at least one operating setting. The first machine learning algorithm can optionally output multiple potential operating settings in sequence, in other words for example a potentially most suitable operating setting first, a potentially second most suitable operating setting second, and so on.

The steps M3 to M5 shown in FIG. 4 are only performed optionally. In step M3 a set of rules that defines non-permissible storage parameters in operating settings for the determined contents is generated based on the determined contents and rules, in which limit values are set for the storage parameters for a predetermined number of categories, to which the determined contents of the storage compartment 10, 11 can be assigned. For example the set of rules can be downloaded from a storage device, in which the rules are stored, based on the objects X1, X2 identified in the storage compartment 10. In step M4 a comparison takes place of the determined operating setting with the set of rules, in which it is checked whether the determined operating setting infringes the set of rules. If so, as shown in FIG. 4 by the symbol “+”, the method moves to step M5, in which a new operating setting is determined. For example in step M4 the potential operating settings output by the first machine learning algorithm in the output sequence are compared with the set of rules and, if the respective operating setting infringes the set of rules, in step M5 the next operating setting in the sequence can be determined as the new operating setting.

If it is determined in step M4 that the set of rules is not infringed, as shown in FIG. 4 by the symbol “−”, the method M moves to steps M6 and M7, which can be performed as alternatives to one another or in combination.

In step M6 the determined operating setting is output at a user interface 4. This can comprise for example the outputting of a visual or acoustic notification, informing a user of the determined operating setting. The outputting of the determined operating setting can take place for example at the user interface 41 of the refrigeration appliance 100. Alternatively or additionally the outputting of the determined operating setting can take place for example at the mobile terminal 42. Depending on whether the first machine learning algorithm is run in the cloud system 6 or in the control device 5 of the refrigeration appliance 100, the determined operating setting can be sent as a dataset from the cloud system 6 directly to the mobile terminal 42 or to the control device 5. The control device 5 prompts the user interface 41 to generate the output or it sends a communication signal to the mobile terminal 42, to prompt it to output the operating setting.

In step M7 the refrigeration appliance 100 is operated according to the determined operating setting to approximate the actual storage conditions in the first storage compartment 10 to the storage parameters defined in the operating setting. For example the control device 5 can generate control signals to operate the refrigerant circuit 2 so that the temperature defined in the operating setting is generated in the first storage compartment 10. The control device 5 can also generate a control signal to vary a position of the separating structure 13 to set the moisture content according to the determined operating setting.

If, as described above, in step M2 an incompatible combination of types is identified in the contents of the first storage compartment 10, in step M2 the first machine learning algorithm can generate a recommendation, which is output at the user interface 4 in step M6. The content of the recommendation can include for example information about a probable maximum shelf life of the incompatible objects, for example “shelf life of lettuce probably less than 2 days”. Alternatively or additionally the content of the recommendation can include tips for changing the composition of the contents, for example “store fish elsewhere”.

When the determined operating setting is being output at the user interface 4, in step M6 an input can also optionally be requested to select the determined operating setting, a user being asked to select or confirm the determined operating setting. The user can actuate an input by way of the user interface 4, for example by touching a button, the input being transferred as a signal to the control device 5. Provision can optionally be made for the refrigeration appliance 100 only to be operated according to the determined operating setting in step M7 if there is a corresponding input at the user interface 4 in response to the input request. The outputting of the determined operating setting at the user interface 4 in step M6 can also comprise the outputting of further operating settings and the outputting of an input request to select the determined operating setting or one of the further operating settings. In step M7 the refrigeration appliance 100 is then operated according to the selected operating setting in response to receipt of an input at the user interface 4 selecting one of the output operating settings.

Although the present invention has been described above by way of example with reference to exemplary embodiments, it is not restricted thereto but can be modified in many different ways. Combinations of the above exemplary embodiments in particular are also conceivable.

The following is a summary list of reference numerals and the corresponding structure used in the above description of the invention:
1 Storage space
2 Refrigerant circuit
3 Imaging sensor
4 User interface
5 Control device
6 Cloud system
10 First storage compartment
10A Drawer
10B Intermediate floor
13 Separating structure
14 Gap
40 Input interface
41 User interface of the refrigeration appliance
42 Mobile terminal
50 Processor
52 Storage medium
100 Refrigeration appliance
110 Body
120 Doors
C1-C9 Types
S1-S56 Check steps
M Method
D3 Dataset
D21, D22 Datasets
D11, D12 Datasets
M1-M7 Method steps
M12, M13 Method steps
NN1 Neural network
NN2 Neural network
X1, X2 Objects

1. A method for operating a refrigeration appliance, which comprises the steps of:
determining contents of a storage compartment of the refrigeration appliance;
determining an operating setting for the refrigeration appliance from a predetermined number of operating settings using a first trained machine learning algorithm based on contents of the storage compartment, wherein each of the operating settings defines a temperature in the storage compartment as at least one storage parameter; and
outputting the operating setting determined at a user interface and/or operating the refrigeration appliance according to the operating setting determined.

2. The method according to claim 1, which further comprises determining the contents of the storage compartment by determining a type and number of objects present in the storage compartment.

3. The method according to claim 2, which further comprises training the first machine learning algorithm to determine the operating setting based on the type and number of the objects determined as being present in the storage compartment.

4. The method according to claim 2, which further comprises training the first machine learning algorithm to identify most sensitive type of objects in the contents determined in respect of storage parameter requirements and to determine the operating setting from the predetermined number of operating settings that defines storage parameters that are compatible with requirements of identified most sensitive type.

5. The method according to claim 1, which further comprises training the first machine learning algorithm to identify combinations of the contents that are incompatible in respect of operating setting requirements and, if an incompatible combination is identified, to generate a recommendation that is output at the user interface and/or to determine a mixed contents operating setting from the predetermined number of operating settings.

6. The method according to claim 1, wherein the step of determining the contents of the storage compartment comprises the sub-steps of:
acquiring image data with an aid of an imaging sensor and determining the objects present in the storage compartment from the image data with an aid of a second trained machine learning algorithm; and/or
receiving an input at the input interface.

7. The method according to claim 1, wherein the operating settings also each define a moisture content in the storage compartment.

8. The method according to claim 7, wherein the storage compartment is defined by a sub-region of a refrigeration space of the refrigeration appliance, wherein an exchange of air between the storage compartment and a rest of the refrigeration space can be varied with an aid of a movable separating structure and a position of the movable separating structure is varied to adjust the moisture content during operation of the refrigeration appliance according to the operating setting.

9. The method according to claim 1, which further comprises:
generating a set of rules, which defines non-permissible storage parameters in the operating settings for the contents determined, based on the contents determined and rules, in which limit values are set for the storage parameters for a predetermined number of categories, to which the contents determined of the storage compartment can be assigned;
comparing the operating setting with the set of rules; and
determining a new operating setting, if the operating setting infringes the set of rules.

10. The method according to claim 9, wherein the first machine learning algorithm outputs multiple potential operating settings in a sequence, wherein the potential operating settings are compared with the set of rules in an output sequence and, if a respective operating setting infringes the set of rules, a next operating setting in the output sequence is determined as a new operating setting.

11. The method according to claim 1, wherein the outputting of the operating setting determined at the user interface contains an input request to select the operating setting determined and the refrigeration appliance is only operated according to the operating setting determined if there is a corresponding input at the user interface in response to the input request.

12. The method according to claim 11, wherein the outputting of the operating setting determined at the user interface also contains an outputting of further operating settings and an outputting of the input request to select the operating setting determined or one of the further operating settings, wherein the refrigeration appliance is operated according to a selected operating setting in response to receipt of an input at the user interface selecting one of the output operating settings.

13. The method according to claim 1, which further comprises operating a refrigerant circuit of the refrigeration appliance during operation of the refrigeration appliance according to the operating setting determined, to vary the temperature in the storage compartment according to the operating setting determined.

14. The method according claim 1, wherein the first machine learning algorithm is stored in a storage medium of the refrigeration appliance and run by a processor of the refrigeration appliance or wherein data specifying the contents is transferred to a web-based virtual machine which runs the first machine learning algorithm stored in a cloud storage device.

15. The method according to claim 1, wherein the outputting of the operating setting determined at the user interface includes generation of an output at the user interface of the refrigeration appliance and/or the outputting of the operating setting determined at the user interface contains a transfer of a communication signal to a mobile terminal and generation of an output by the mobile terminal to output the operating setting determined in response to receipt of the communication signal.
